(19) United States
(12) Patent Application Publication
(10) Pub. No.: US 2015/0099168 A1
(43) Pub. Date: Apr. 9, 2015

(54) REINFORCED BATTERY SEPARATOR AND METHODS OF USE THEREFOR

(71) Applicant: JOHNS MANVILLE, Denver, CO (US)

(72) Inventors: Zhihua Guo, Centennial, CO (US); Guodong Zheng, Highlands Ranch, CO (US); Souvik Nandi, Highlands Ranch, CO (US); Jawed Asrar, Englewood, CO (US)

(73) Assignee: JOHNS MANVILLE, Denver, CO (US)

(21) Appl. No.: 14/048,713

(22) Filed: Oct. 8, 2013

(51) Int. Cl. H01M 2/16; B29D 99/00; H01M 2/14

(52) U.S. Cl. CPC H01M 2/1613; H01M 2/145; B29D 99/005; B29K 2023/0683
USPC 429/212; 429/249; 216/56

(57) ABSTRACT

According to one embodiment, a separator for a lead-acid battery includes a membrane film of an ultra-high molecular weight polymer material (UHMWPE). Precipitated silica and glass fibers are disposed throughout the membrane film and held or maintained in position by the UHMWPE. The separator may have a thickness of between 1 and 50 mils and include between 10% and 30% by weight of the UHMWPE, between 40% and 80% by weight of the precipitated silica, between 5% and 25% by weight of processing oils, and between 1% and 30% by weight of the glass fibers.

### BACKGROUND OF THE INVENTION

Lead-acid batteries are characterized as being inexpensive and highly reliable. Therefore, they are widely used as an electrical power source for starting motor vehicles or golf carts and other electric vehicles. In recent years, a variety of measures to improve fuel efficiency have been considered in order to prevent atmospheric pollution and global warming. Examples of motor vehicles subjected to fuel-efficiency improvement measures that are being considered include idling stop vehicles (ISS vehicles) where the engine is stopped when the vehicle is not in motion to prevent unnecessary idling of the engine and to reduce engine operation time. Other uses of lead-acid batteries are also being explored. Because the demand for lead-acid batteries continues to increase, the demand for improved lead-acid batteries also continues to increase.

### BRIEF SUMMARY OF THE INVENTION

The embodiments described herein provide battery separators having improved structural characteristics. According to one embodiment, a separator for a lead-acid battery is provided. The separator includes a membrane film of an ultra-high molecular weight polymer material (UHMW). The UHMW material is commonly UHMW polyolefin, in particular UHMW polyethylene (UHMWPE). For convenience in describing the embodiments, the application will refer to the UHMW material as generally being UHMWPE, although it should be realized that other materials, such as UHMW polyolefin and the like, may be used instead of or in addition to UHMWPE.

Precipitated silica is disposed throughout the membrane film and is held or maintained in position within the membrane film by the UHMWPE. A plurality of glass fibers are also disposed throughout the membrane film. The separator has a thickness of between 1 and 50 mils, and more commonly 3-20 mils, and includes between 10% and 30% by weight of the UHMWPE (and commonly about 20%), between 40% and 80% by weight of the precipitated silica (and commonly about 60%), between 5% and 25% by weight of processing oils (and commonly about 15%), and between 1% and 30% by weight of the glass fibers.

In some embodiments, the glass fibers may have an average fiber diameter of between 5 and 30 μm. The separator may include glass fibers having a fiber length of between 0.0001 and 10 inches, and more commonly between 0.01 and 0.5 inches. In a specific embodiment, the separator may include glass fibers having a fiber length of between 0.03 and 0.25 inches (i.e., between about 0.75 mm and 6.5 mm). In some embodiments, chopped glass fibers having fiber lengths of between about 1.5 and 55 mm and more commonly 3 and 25 mm, or continuous fibers, may be extruded with the membrane film materials to produce the above described separators. The glass fibers may be disposed throughout the membrane film by forming a composite of the glass fibers and the ultra-high molecular weight polymer material. The UHMWPE may be polyolefin having a weight-average molecular weight of 500,000 or more.

According to another embodiment, a method of manufacturing a separator for a lead-acid battery is provided. The method includes blending a plurality of components together to form a material agglomerate. The plurality of components may include: an ultra-high molecular weight polymer material having a weight-average molecular weight of 500,000 or more, precipitated silica, one or more processing oils, and/or a plurality of glass fibers, and other processing aids, like antioxidants and/or surface tension modifiers. The precipitated silica and plurality of glass fibers may be disposed throughout the ultra-high molecular weight polymer material. The method may also include passing the material through a heated extruder, passing the material through a pair of rollers to form a membrane film from the material, applying a solvent to the material to remove a substantial portion of the one or more processing oils, and drying the membrane film to form the separator.

In some embodiments, the resulting separator has a thickness of between 1 and 50 mils, and more commonly 3-20 mils, and includes between 10 and 30% of the ultra-high molecular weight polymer material by weight (and commonly about 20%), between 40 and 80% of the precipitated silica by weight (and commonly about 60%), and between 1 and 30% of the glass fibers by weight. In some embodiments, blending of the plurality of glass fibers and the UHMWPE forms a composite of the glass fibers and the UHMWPE. In other embodiments, blending of the plurality of glass fibers and the UHMWPE occurs by adding the glass fibers to the UHMWPE as the UHMWPE is passed through the heated extruder.

In some embodiments, the glass fibers have an average fiber diameter of between 5 and 30 μm. In some embodiments, the glass fibers include chopped fibers having an average fiber length of between 4 and 6 mm prior to extrusion of the material and an average fiber length of between 0.75 mm and 3 mm subsequent to extrusion.

In some embodiments, the method may additionally include heating the material to between about 30 and 100 degrees Celsius above the melting temperature of the UHMWPE during extrusion and cooling the UHMWPE to below the melting point of the UHMWPE prior to passing the material through the pair of rollers. In some embodiments, the method may additionally include passing the extruded material through a die prior to passing the material through the pair of rollers. In some embodiments, the method may additionally include adding one or more additional components to the material. The additional components include: mineral process oil, antioxidants, and/or surface tension modifiers. In some embodiments, the method may additionally include slitting the membrane film to form at least two sheets of the membrane film material of a predetermined width and winding the sheets of the membrane film material into rolls.

According to another embodiment, a lead-acid battery is provided. The lead-acid battery includes: a positive electrode, a negative electrode, and a battery separator positioned between the positive electrode and the negative electrode so as to electrically separate the positive and negative electrodes. The battery separator includes a membrane film of an ultra-high molecular weight polymer material (UHMWPE), precipitated silica disposed throughout the membrane film, and a plurality of glass fibers disposed throughout the membrane film. The precipitated silica and/or glass fibers may be maintained in position within the membrane film by the UHMWPE. The separator may have a thickness of between 1 and 50 mils, and more commonly 3-20 mils, and include between 10% and 30% of the UHMWPE (and commonly about 20%), between 40% and 80% of the precipitated silica by weight (and commonly 60%), between 5% and 25% by weight of processing oils (and commonly about 15%), and between 1% and 30% of the glass fibers by weight.

### BRIEF DESCRIPTION OF THE DRAWINGS

The present invention is described in conjunction with the appended figures:

FIG. 1 illustrates a battery separator for separating oppositely charged plates or electrodes of a lead-acid battery, according to an embodiment.

FIG. 2 illustrates a front exploded view of a lead-acid battery cell, according to an embodiment.

FIG. 3 is a method of manufacturing a battery separator, according to an embodiment.

In the appended figures, similar components and/or features may have the same numerical reference label. Further, various components of the same type may be distinguished by following the reference label by a letter that distinguishes among the similar components and/or features. If only the first numerical reference label is used in the specification, the description is applicable to any one of the similar components and/or features having the same first numerical reference label irrespective of the letter suffix.

### DETAILED DESCRIPTION OF THE INVENTION

The ensuing description provides exemplary embodiments only, and is not intended to limit the scope, applicability or configuration of the disclosure. Rather, the ensuing description of the exemplary embodiments will provide those skilled in the art with an enabling description for implementing one or more exemplary embodiments. It being understood that various changes may be made in the function and arrangement of elements without departing from the spirit and scope of the invention as set forth in the appended claims.

The embodiments described herein provide battery separators having improved structural characteristics when compared with conventional battery separators. Specifically, the structural characteristics of the battery separator are improved by incorporating the reinforcement layer or mat within the polymer membrane battery separator. Conventional battery separators commonly include a polymer membrane that functions to physically and electrically isolate the oppositely charged plates of a battery (i.e. the negative and positive electrodes). The polymer membrane prevents the oppositely charged plates from contacting one another and forming a short. As as the battery is repeatedly charged and discharged, lead or lead oxide crystals (i.e. dendrite) begin to form within the battery. Without the use of a polymer membrane, the crystals of lead or lead oxide may eventually contact one another and thereby short the battery, or shorten the life of the battery. The polymer membranes are flexible materials that prevent the lead or lead oxide crystals (i.e., dendrite) from protruding through the separator and shorting the battery.

The polymer membranes, however, are typically dimensionally unstable and/or relatively weak. To reinforce the polymer material, reinforcement mats are commonly positioned and bonded to one or more sides of the polymer membrane. For example, in some embodiments glass fiber mats may be bonded to one or more surfaces of the polymer membrane to reinforce the membrane. A potential problem with such a reinforcement mats is that the mats may form a web in which gas bubbles may be trapped. The gas bubbles may be relatively small and may remain trapped or imbedded within the glass fiber mat web. As gas bubbles accumulate within the glass fiber mat web, the internal resistance of the battery cell may be increased, which may lower the current output for the battery cell.

In the embodiments described herein, the reinforcement mat is integrated or dispersed within the separator's polymer membrane so as to eliminate the need for an additional reinforcement mat. In one embodiment, the fibers of the reinforcement mat may be included or dispersed within the polymer membrane. The fibers may be dispersed within the polymer membrane in a relatively homogenous manner so as to minimize or eliminate fiber bundles within the polymer membrane. For ease in describing the embodiments herein, the fibers that are integrated or disposed within the polymer membrane will be referred to generally as glass fibers, although it should be realized that other fibers, such as polymer fibers, natural fibers, and the like may be used in any of the embodiments described herein.

The integrated glass fibers can greatly improve or increase the strength of the separator's polymer membrane. In some embodiments, an additional reinforcement mat (e.g. a glass mat) may be used to reinforce the polymer membrane having integrated glass fibers. Stated differently, in some embodiments, the polymer membrane having integrated glass fibers may still be reinforced with a glass fiber or other reinforcement mat. The glass fiber or other reinforcement mat, however, may be thinner than conventional reinforcement mats commonly used since the polymer membrane already includes reinforcing fibers. The thinner reinforcement mats may reduce or eliminate the gas bubble trapping issues previously described.

In another embodiment, the glass fiber or other reinforcement mat is not needed since the glass fiber reinforced polymer membrane has sufficient dimensinoal stability and strength. In such embodiments, gas bubble trapping issues on the reinforcement mat are essentially eliminated since a reinforcement mat is not included. As such, issues with increased internal resistance of the battery cell and/or lower current output are essentially resolved due to the elimination or reduction of gas bubble trapping within the battery cell.

In one embodiment, to integrate or dispose the glass fibers within the polymer membrane, a polymer and glass fiber material composite may be formed and then the composite may be formed into a separator membrane. In another embodiment, the glass fibers may be integrated or disposed within the polymer membrane by adding glass fibers to the polymer material during the formation of the separator membrane, such as during extrusoin of the polymer and/or other material. In some embodiments, the resulting battery separator may include between about 1% and about 30% by weight of glass fibers. Having described embodiments generally, additional aspects and features will be recognized with reference to the figures, which are described below.

### Embodiments

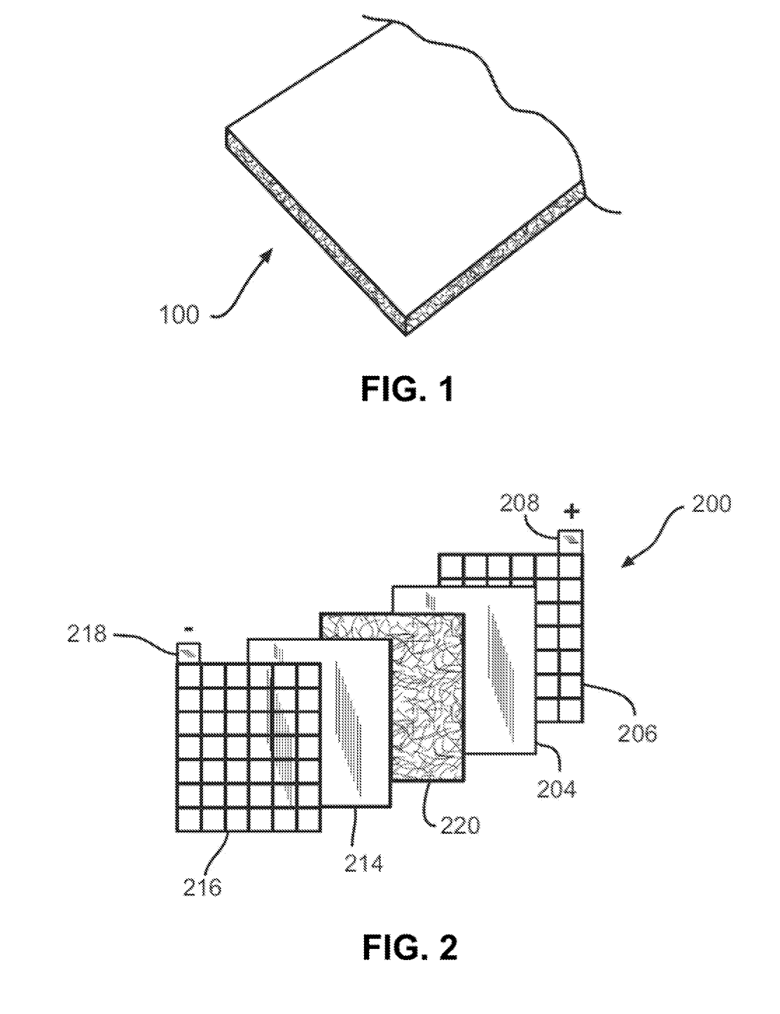

Referring now to FIG. 1, illustrated is an embodiment of a battery separator 100 for separating oppositely charged plates or electrodes of a lead-acid battery (hereinafter separator 100). Specifically, separator 100 is positioned between a positive electrode and a negative electrode to physically separate the two electrodes while enabling ionic transport, thus completing a circuit and allowing an electronic current to flow between a positive terminal and a negative terminal of the battery. Separator 100 includes a microporous membrane, which is typically a polymeric film having negligible conductance. The polymeric film includes micro-sized voids that allow ionic transport (i.e., transport of ionic charge carriers) across separator 100.

The polymeric film of separator 100 is commonly an agglomerate of various materials. For example, separator 100 typically includes an ultra-high molecular weight polymer material (e.g., UHMWPE). In one embodiment, the UHMW material is polyolefin, which may include polyethylene (PE), polypropylene (PP), and the like. The UHMW material may have a weight-average molecular weight of 500,000 or more. The other materials of separator 100 are commonly held within a network of extremely long chains of the UHMWPE. Separator 100 also typically includes precipitated silica, which is disposed throughout the UHMWPE. As previously described, the precipitated silica is maintained or held in position within the UHMWPE by the network of extremely long UHMWPE chains.

Separator 100 also includes a plurality of glass fibers that are disposed throughout the UHMWPE. Like the precipitated silica, the glass fibers are maintained or held in position within the UHMWPE by the network of extremely long UHMWPE chains. The glass fibers typically have an average fiber diameter of between 5 and 30 μm, and more commonly between about 10 and 20 μm. In a specific embodiment, the glass fibers have an average diameter of between about 10 and 15 μm. The glass fibers may include chopped fibers having an average fiber length of 3 and 25 mm, and more commonly between about 4 and 6 mm. In some embodiments, the average length of the glass fibers may decrease substantially subsequent to formation of separator 100. For example, subsequent to formation of separator 100, the average fiber length of the glass fibers may be between about 0.03 and 0.25 inches. As described above, in some embodiments, the resulting separator product may include glass fibers having a fiber length of between 0.0001 and 10 inches, and more commonly between 0.01 and 0.5 inches. In a specific embodiment, the separator may include glass fibers having a fiber length of between 0.03 and 0.25 inches.

In some embodiments, the glass fibers may be added to the polymer material of separator 100 in the form of strands. The glass fiber strands may include up to 1000 or more of the individual glass fibers coupled together. After being added to the polymer material, the individual glass fibers of the strands may separate and disperse within the polymer material. In some embodiments, the glass fibers and/or glass fiber strands may be added to the polymer material to form a composite of the polymer material and glass fibers, or the glass fibers and/or glass fiber strands may be added to the polymer material during formation of separator 100, such as prior to or simultaneously with extrusion of the polymer material. Separation of the individual glass fibers increases the surface area of the glass fibers within the polymer material and/or allows the glass fibers to be relatively homogenously mixed within the polymer material. The increased surface area of the glass fibers also allows the individual fibers to easily entangle with one another to reinforce the polymer membrane of separator 100.

Other filler materials may be added to the polymer material of separator 100. For example, a variety of processing oils may be added to the polymer material to help the material during the formation of separator 100. The processing oils may help the polymer material during extrusion and/or rolling processes by reducing the viscosity of the polymer material agglomerate. After formation of the separator 100, or during one of the processes of making separator 100, the processing oil may be removed, such as by using one or more solvent materials. In some embodiments, silica powder may also be added to the polymer material. The silica powder may be added to make the separator 100 more hydrophilic.

In one embodiment, separator 100 may have a thickness of between about 1 and 50 mils and more commonly 3-20 mils. The separator 100 may also include between about 10% and 30% by weight of the ultra-high molecular weight polymer material (e.g., UHMWPE and the like). Separator 100 may also include between 40% and 80% by weight of the precipitated silica, between 5% and 25% by weight of processing oils, and between 1% and 30% by weight of the glass fibers. In another embodiment, separator 100 includes about 20% of the UHMWPE, about 15% processing oils, about 40-60% precipitated silicas, and between about 15-25% glass fibers. The more glass fibers that are added to the polymer material, the greater the reinforcement of the resulting separator 100.

In some embodiments, an additional glass fiber or other reinforcement mat may be bonded to one or more surfaces of separator 100 to provide additional reinforcement of separator 100. In some embodiments, the additional reinforcement mat may be used when separator 100 includes relatively low glass fiber concentrations, such as less than 10% by weight glass fibers. The additional glass fiber or other reinforcement mat may have a thickness and/or glass fiber concentration that is less than conventional reinforcement mats due to the presence of glass fibers within separtor 100.

Referring now to FIG. 2, illustrated is front exploded view of a lead-acid battery cell 200. The lead-acid batter cell 200 may represent a cell used in a flooded lead-acid battery. Each cell 200 may provide an electromotive force (emf) of about 2.1 volts and a lead-acid battery may include 3 such cells 200 connected in series to provide an emf of about 6.3 volts or may include 6 such cells 200 connected in series to provide an emf of about 12.6 volts, and the like. Cell 200 includes a positive plate or electrode 204 and a negative plate or electrode 214 separated by battery separator 220. Positive electrode 204 includes a grid or conductor 206 of lead alloy material. A positive active material (not shown), such as lead dioxide, is typically coated or pasted on grid 206. Grid 206 is also electrically coupled with a positive terminal 208. In some embodiments, a pasting paper or glass mat (not shown) may be coupled with grid 206 and the positive active material. The pasting paper or glass mat may provide structural support for the grid 206 and positive active material.

Similarly, negative electrode 214 includes a grid or conductor 216 of lead alloy material that is coated or pasted with a negative active material (not shown), such as lead. Grid 216 is electrically coupled with a negative terminal 218. A pasting paper or glass mat (not shown) may also be coupled with grid 216 and the negative active material. The pasting paper or glass mat may provide structural support for the grid 216 and negative active material. In flooded type lead-acid batteries, positive electrode 202 and negative electrode 212 are immersed in an electrolyte (not shown) that may include a sulfuric acid and water solution.

As described herein, separator 220 includes a membrane film of an ultra-high molecular weight polymer material (UHMWPE). Separator 220 also includes a plurality of glass fibers disposed throughout the membrane film so as to reinforce the membrane film. Separator 220 typically also includes other filler type materials, such as precipitated silica disposed throughout the membrane film, processing oils, and the like. The precipitated silica and/or glass fibers may be maintained in position within the membrane film via a network of the UHMW polymer material.

In one embodiment, separator 220 may have a thickness of between 1 and 50 mils, and more commonly 3-20 mils, and may include between 10% and 30% by weight of the UHMW polymer material, between 40% and 80% by weight of the precipitated silica, between 5% and 25% by weight of processing oils, and between 1% and 30% by weight of the glass fibers. In a specific embodiment, separator 220 includes about 20% by weight UHMWPE, about 40-60% by weight of precipitated silica, about 15% by weight processing oils, and between 1% and 30% by weight of the glass fibers. In some embodiments, a reinforcement mat (not shown) may be attached to one or more surfaces of the separator 220. The reinforcement mat may include a plurality of entangled glass fibers and may have a thinner cross-sectional thickness and/or lower overall concentration of glass fibers than conventional separator reinforcement mats. In some embodiments, a reinforcement mat may be included on opposite sides of the separator 220, such that the separator 220 is sandwiched between two reinforcement mats. In other embodiments, separator 220 is not coupled or bonded with any reinforcement mats. Rather, separator 220 may be sufficiently reinforced and/or dimensional stable due to the presence of the glass fibers dispersed within the membrane film. In such embodiments, issues related to gas bubble formation and/or trapping within a reinforcement mat may be eliminated or reduced.

### Methods

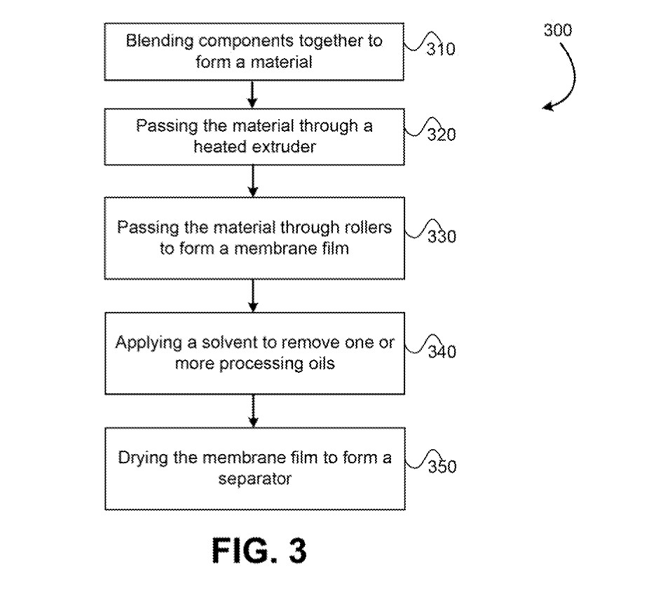

Referring now to FIG. 3, illustrated is an embodiment of a method 300 of manufacturing a separator for a lead-acid battery (hereinafter separator). At block 310, a plurality of components is blended together to form a material agglomerate. As described herein, the plurality of components may include: an ultra-high molecular weight polymer material (UHMWPE) having a weight-average molecular weight of 500,000 or more, precipitated silica, one or more processing oils, and/or a plurality of glass fibers. The precipitated silica and/or plurality of glass fibers may be disposed throughout the UHMWPE and maintained in place via a network of extremely long chains of the UHMWPE. The processing oils may be added to the UHMW polymer material to help the material during an extrusion or other process. The processing oils may reduce the viscosity of the UHMWPE so as to enable the UHMWPE to be extruded. Silica powder may be added to the UHMWPE to make the resulting separator more hydrophilic.

In some embodiments, the glass fibers are made as short bundles or strands, typically with up to 1000 individual fibers coupled together. The bundles or strands may be sprayed with a lubricant to prevent the individual fibers from sticking together. In other embodiment, continuous glass fibers, such as rovings, may be used instead of or in addition to the short bundles or strands. In one embodiment, the plurality of glass fibers may be blended with the UHMWPE to form a composite of the glass fibers and UHMWPE. Further processing of the composite (e.g., extrusion and rolling) may then be performed. In another embodiment, the plurality of glass fibers may be added to the UHMW polymer material as the UHMWPE and/or other agglomerate components are passed through a heated extruder (block 320).

Feeding the agglomerate material into the heated extruder (block 320), and/or forming the composite material, may uncouple the glass fibers from the fiber bundles or strands into individual or mainly individual glass fibers. The glass fibers may separate during the extrusion process as the UHMW polymer material is mixed due to the viscosity of the UHMWPE. Separating the individual glass fibers increases the surface area of the glass fibers and homogenously mixes the glass fibers within the UHMW polymer material. The increased surface area of the glass fibers allows the fibers to easily entangle and reinforce the membrane.

For the extrusion process, the UHMWPE may be added by between 5 and 25% by weight, and more commonly between 10 and 20% by weight. The proceesing oil may be added by between 50 and 80% by weight. Similarly, the precipitated silica may be added by between 15 and 30% by weight, while the glass fibers may be added between 1 and 30% by weight depending on how much reinforcement is desired. For example, less glass fibers (e.g., 10% or less) may be added when one or more reinforcement mats are going to be coupled with the separator while more glass fibers (e.g., more than 10%) may be added when no reinforcement mats are used. Lower amounts of glass fibers may increase the ease in manufacturing the separators, but may require additional reinforcement via one or more reinforcement mats. In contrast, greater amounts of glass fibers may negate the need for an additional reinforcement mat, but increaes the difficulty in manufacturing the separators. It should be realized that the above material ratios are used during the extrusion process and that the material concentrations typically differ post-extrusion. For example, the majority of the processing oils are extracted post-extrusion such that the resulting separator typically includes between 10% and 30% by weight (commonly about 20%), between 40% and 80% by weight of precipitated silica (commonly about 60%), between 5% and 25% by weight processing oils (commonly about 15%), and between 1% and 30% by weight of glass fibers as described above.

The glass fibers may have an average fiber diameter of between 5 and 30 μm, and more commonly between about 10 and 20 μm. In a specific embodiment, the glass fibers have an average diameter of between about 10 and 15 μm. The glass fibers may also have an average fiber length of between 3 and 25 mm, and more commonly between about 4 and 6 mm. In one embodiment, the length of the glass fibers may decrease significantly after extrusion of the UHMW/glass fiber material. For example, the glass fibers may have an average fiber length of between 4 and 6 mm prior to extrusion, and an average fiber length of between 0.75 and 3 mm subsequent to extrusion.

In some embodiments, the agglomerate material may be cut into pellets after the extrusion process (block 320). The pellets may then be used in a subsequent process or processes to form the separator material. For example, the pellets may be heated and/or melted and passed through a roller (block 330) to form a membrane film. In another embodiment, the pellets may be used in an injection mold process to form a membrane film.

As shown in block 330, the material may be passed through a pair of rollers to form a membrane film from the agglomerate material. The material may be passed through the rollers shortly after extrusion (block 320), or pellets or another substance may be formed and subsequently used during the rolling or other processes. In one embodiment, the agglomerate material may be heated to between about 30 and 100 degrees Celsius above the melting temperature of the UHMW polymer material during extrusion (block 320) and cooled to below the melting point of the UHMW polymer material prior to passing the material through the pair of rollers (block 330). In some embodiments, the extruded agglomerate material may be passed through a die prior to passing the material through the pair of rollers.

At block 340, a solvent may be applied to the material to remove or extract a substantial portion of the one or more processing oils. Extracting the processing oils may make the membrane film porous. At block 350, the membrane film may be dried to form the separator. The resulting separator may have a thickness of between 1 and 50 mils, and more commonly between 3 and 20 mils.

In some embodiments, one or more additional components may be added to the agglomerate material. The additional components may include: mineral process oil, antioxidants, and/or surface tension modifiers. In some embodiments, the method may further include slitting the membrane film to form at least two sheets of the membrane film material of a predetermined width and winding the sheets of the membrane film material into rolls.

### Examples

In a specific embodiment, an agglomerate material having a volumetric ratio of UHMWPE (e.g., polyethylene)/silica/process oil of approximately 10%:15%:75%, respectively, was fed through a Leistritz® 27mm Co-Rotating Twin-Screw Extruder (Model ZSE27, L/D=40). The weight ratio of the above agglomerate material was respectively 9%:27%:64%. 30% glass fibers by weight were added to the agglomerate material during the extrusion process. The added glass material was ThermoFlow® 636 (i.e., chopped strand extrusion compounding) glass fibers sold by Johns Manville®. The glass fibers had a fiber length of approximately 4 mm and an average fiber diameter of approximately 13 μm. The glass fibers were mixed with the UHMWPE to produce a separator having enhanced reinforcement and/or dimensionally stable properties. The processing oil used was ConoPure™ Process oil 12P from ConocoPhillips. The UHWM material was Ultra High Molecular Weight Polyethylene GUR® 4120 from Ticona. The silica was Hi-Sil™ 233 from PPG Industries, Inc. A heat of approximately 190 C was used across the extruder.

Having described several embodiments, it will be recognized by those of skill in the art that various modifications, alternative constructions, and equivalents may be used without departing from the spirit of the invention. Additionally, a number of well-known processes and elements have not been described in order to avoid unnecessarily obscuring the present invention. Accordingly, the above description should not be taken as limiting the scope of the invention.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included.

As used herein and in the appended claims, the singular forms “a”, “an”, and “the” include plural referents unless the context clearly dictates otherwise. Thus, for example, reference to “a process” includes a plurality of such processes and reference to “the device” includes reference to one or more devices and equivalents thereof known to those skilled in the art, and so forth.

Also, the words “comprise,” “comprising,” “include,” “including,” and “includes” when used in this specification and in the following claims are intended to specify the presence of stated features, integers, components, or steps, but they do not preclude the presence or addition of one or more other features, integers, components, steps, acts, or groups.

What is claimed is:

1. A separator for a lead-acid battery comprising:
a membrane film of an ultra-high molecular weight polymer material;
precipitated silica disposed throughout the membrane film, the precipitated silica being maintained in position within the membrane film by the ultra-high molecular weight polymer material; and
a plurality of glass fibers disposed throughout the membrane film;
wherein the separator comprises:
a thickness of between 1 and 50 mils;
between 10% and 30% by weight of the ultra-high molecular weight polymer material;
between 40% and 80% by weight of the precipitated silica;
between 5% and 25% by weight of processing oils; and
between 1% and 30% by weight of the glass fibers.

2. The separator of claim 1, wherein the glass fibers have an average fiber diameter of between 5 and 30 μm.

3. The separator of claim 2, wherein the glass fibers comprise chopped fibers having an average fiber length of between 0.03 and 0.25 inches.

4. The separator of claim 1, wherein the glass fibers are disposed throughout the membrane film by forming a composite of the glass fibers and the ultra-high molecular weight polymer material.

5. The separator of claim 1, wherein the ultra-high molecular weight polymer material includes polyolefin having a weight-average molecular weight of 500,000 or more.

6. A method of manufacturing a separator for a lead-acid battery, the method comprising:
blending a plurality of components together to form a material agglomerate, the plurality of components including:
an ultra-high molecular weight polymer material having a weight-average molecular weight of 500,000 or more;
precipitated silica;
one or more processing oils; and
a plurality of glass fibers, wherein the precipitated silica and plurality of glass fibers are disposed throughout the ultra-high molecular weight polymer material;
passing the material through a heated extruder;
passing the material through a pair of rollers to form a membrane film from the material;
applying a solvent to the material to remove a substantial portion of the one or more processing oils; and
drying the membrane film to form the separator.

7. The method of claim 6, wherein the separator comprises a thickness of between 1 and 50 mils, and wherein the separator comprises:
between 10 and 30% of the ultra-high molecular weight polymer material by weight;
between 40 and 80% of the precipitated silica by weight;
between 5% and 25% of processing oils by weight; and
between 1 and 30% of the glass fibers by weight.

8. The method of claim 6, wherein blending of the plurality of glass fibers and the ultra-high molecular weight polymer material forms a composite of the glass fibers and the ultra-high molecular weight polymer material.

9. The method of claim 6, wherein blending of the plurality of glass fibers and the ultra-high molecular weight polymer material occurs by adding the glass fibers to the ultra-high molecular weight polymer material as the ultra-high molecular weight polymer material is passed through the heated extruder.

10. The method of claim 6, wherein the glass fibers have an average fiber diameter of between 5 and 30 μm.

11. The method of claim 10, wherein the glass fibers comprise chopped fibers having an average fiber length of between 4 and 6 mm prior to extrusion of the material, and wherein the glass fibers comprise an average fiber length of between 0.75 and 3 mm subsequent to extrusion.

12. The method of claim 6, further comprising heating the material to between about 30 and 100 degrees Celsius above the melting temperature of the ultra-high molecular weight polymer material during extrusion and cooling the ultra-high molecular weight polymer material to below the melting point of the ultra-high molecular weight polymer material prior to passing the material through the pair of rollers.

13. The method of claim 6, further comprising passing the extruded material through a die prior to passing the material through the pair of rollers.

14. The method of claim 6, further comprising adding one or more additional components to the material, the additional components being selected from the group consisting of:
mineral process oil;
antioxidants; and
surface tension modifiers.

15. The method of claim 6, further comprising slitting the membrane film to form at least two sheets of the membrane film material of a predetermined width, and winding the sheets of the membrane film material into rolls.

16. A lead-acid battery comprising:
a positive electrode;
a negative electrode; and
a battery separator positioned between the positive electrode and the negative electrode so as to electrically separate the positive and negative electrodes, the battery separator comprising:
a membrane film of an ultra-high molecular weight polymer material;
precipitated silica disposed throughout the membrane film, the precipitated silica being maintained in position within the membrane film by the ultra-high molecular weight polymer material; and
a plurality of glass fibers disposed throughout the membrane film, wherein the separator comprises:
a thickness of between 1 and 50 mils;
between 10% and 30% of the ultra-high molecular weight polymer material by weight;
between 40% and 80% of the precipitated silica by weight;
between 5% and 25% of processing oils by weight; and
between 1% and 30% of the glass fibers by weight.

17. The lead-acid battery of claim 16, wherein the glass fibers have an average fiber diameter of between 5 and 30 μm.

18. The lead-acid battery of claim 17, wherein the glass fibers comprise chopped fibers having an average fiber length of between 0.03 and 0.25 inches.

19. The lead-acid battery of claim 16, wherein the glass fibers are disposed throughout the membrane film by forming a composite of the glass fibers and the ultra-high molecular weight polymer material.

20. The lead-acid battery of claim 16, wherein the ultra-high molecular weight polymer material includes polyolefin having a weight-average molecular weight of 500,000 or more.
